(19) United States
(12) Patent Application Publication
(10) Pub. No.: US 2026/0209642 A1
(43) Pub. Date: Jul. 23, 2026

(54) PROCESS FOR MAKING A POWDER OR GRANULE CONTAINING A CHELATING AGENT

(71) Applicant: BASF SE, Ludwigshafen am Rhein (DE)

(72) Inventors: Matthias ARNDT, Ludwigshafen am Rhein (DE); Michael Klemens MUELLER, Ludwigshafen am Rhein (DE); Markus HARTMANN, Ludwigshafen am Rhein (DE); Astrid SCHMIDT, Ludwigshafen am Rhein (DE); Frank JAEKEL, Ludwigshafen am Rhein (DE); Marta REINOSO GARCIA, Ludwigshafen am Rhein (DE)

(21) Appl. No.: 19/141,844

(22) PCT Filed: Dec. 11, 2023
(86) PCT No.: PCT/EP2023/085055

§ 371 Date: Jun. 20, 2025

(30) Foreign Application Priority Data
Dec. 20, 2022 (EP) 22214980.9
Dec. 20, 2022 (EP) 22214983.3

(51) Int. Cl. C11D 3/33; C11D 3/20; C11D 3/37; C11D 3/48; C11D 17/06

(52) U.S. Cl. CPC C11D 3/33; C11D 3/2086; C11D 3/3761; C11D 3/48; C11D 17/06

(57) ABSTRACT

The present invention deals with a process for making a powder or granule containing at least one chelating agent.

The present invention deals with a process for making a powder or granule containing at least one chelating agent, a powder or granule, obtained or obtainable according to the inventive process, and the use of a powder or granule, obtained or obtainable according to the inventive process, in laundry application, dishwashing applications or in industrial and institutional cleaning applications.

Chelating agents (also referred to as “complexing agents” hereinafter) such as methyl glycine diacetic acid (MGDA) and glutamic acid diacetic acid (GLDA) and their respective alkali metal salts are useful sequestrants for alkaline earth metal ions such as Ca²⁺ and Mg²⁺. For that reason, they are recommended and used for various purposes such as laundry detergents and for automatic dishwashing (ADW) formulations, in particular for so-called phosphate-free laundry detergents and phosphate-free ADW formulations. For shipping such complexing agents, in most cases either solids such as granules are being applied or aqueous solutions.

Granules and powders have the advantage of being essentially water-free. That means that in case of shipping, no water has to be shipped, and costs for extra weight can be avoided.

Many industrial users prefer to use chelating agents in the form of granules or powders which may contain, in addition to the at least one chelating agent, at least one additional compound, in particular polymers.

Methods for providing granules or powders of chelating agents, also in combination with other compounds like polymers, have been described in the art, for example in WO 2015/121170 A1.

However, conventional processes to prepare chelating agents, e. g. aminocarboxylate chelating agents, in solid form, are associated with disadvantages.

For example, a considerable amount of the solid products obtained from a spray granulation process tend to show an unwanted yellowing in the presence of percarbonates (“percarbonate stability test”), which are frequently found in cleaning products also containing aminocarboxylate chelating agents, and show a tendency to adsorb water (high hygroscopicity), which is undesirable. Besides, solid aminocarboxylate complexing agents sometimes show an unpleasant odour.

Furthermore, the manufacturing processes to obtain solid products containing chelating agents, like aminocarboxylates, as such suffer from problems and disadvantages. For example, it is sometimes difficult or even impossible to combine chelating agents with certain other compounds (which may be desirable for customers) in a solid product, e. g. granule, in a one-step or one-zone spray-granulating process, due to certain incompatibilities. Another example is certain compounds, e. g. polymers, which may in principle be co-granulated (in a one-step/one-zone process) with chelating agents (like MGDA), but not in the desired (higher) amounts.

Thus, one objective of the present invention was to overcome the problems and disadvantages mentioned above.

In particular, it was an objective of the present invention to provide a process for making a powder or granule containing at least one complexing agent, e. g. a solid alkali metal salt (A) of an aminocarboxylate complexing agent, which leads to stabler products (in particular to products with a lower tendency for yellowing in the presence of percarbonates) and/or with a lower hygroscopicity. Furthermore, it was an objective of the present invention to provide a process for making a powder or granule containing at least one complexing agent, wherein the powder or granule shows less (unpleasant) odour.

Besides, it was an objective of the present invention to provide a process for making a powder or granule containing at least one complexing agent, e. g. a solid alkali metal salt (A) of an aminocarboxylate complexing agent, which is easy to handle and overcomes the processual problems mentioned above, e. g. which allows to combine at least one complexing agent, e. g. a solid alkali metal salt (A) of an aminocarboxylate complexing agent, with other compounds which are difficult to handle and/or are incompatible with the respective complexing agent to some extent.

The inventors have now surprisingly found that by sprinkling certain additives on the surface of an intermediate powder or granule, in a process for making a powder or granule of a chelating agent, the problem may be solved. The respective products are considerably more stable and show a considerably lower tendency for yellowing in the presence of percarbonates. In addition, the products may show less of an unpleasant odour.

Thus, one subject of the present invention is a process for making a powder (P) or granule (G) containing
(a) at least one chelating agent (A), preferably selected from methyl glycine diacetic acid (MGDA), glutamic acid diacetate (GLDA), iminodisuccinic acid (IDS), citric acid and Ethylediamine disuccinic acid (EDDS), their respective alkali metal salts and their mixtures, and (b) optionally, at least one polymer, preferably in an amount of up to 50 wt % (relative to the total weight of the powder or granule (more preferably 5 to 30 wt %), preferably homo- or copolymer (B) of (meth)acrylic acid, partially or fully neutralized with alkali,
   said process comprising the steps of
   (i) mixing the at least one chelating agent (A) and, optionally, the at least one homo- or copolymer (B) in the presence of water,
   (ii) removing most of said water by spray-drying or spray granulation, preferably using a gas with an inlet temperature of at least 125° C., to obtain intermediate powder (IP) or granule (IG), and
   (iii) sprinkling at least one additive (C) in an amount of up to 50% by weight, relative to the complete weight of the resulting powder (P) or granule (G), preferably contained in a solution or slurry, on the surface of intermediate powder or granule (I), to obtain final powder (P) or granule (G),
   wherein, preferably, the process is performed in a multizone and/or multinozzle apparatus, more preferably in a multizone and/or multinozzle fluid bed spray granulation apparatus.

The term “sprinkling” (as opposed to a coating) in the present invention may refer to the covering of the surface of the inventive powder or granule, which may be partial, but preferably leads to a closed surface.

Optionally, the obtained powder (P) or granule (G) may be compacted.

The inventive process may be continuous or a batch process. “Batch process” in the present context means that step (iii) follows after steps (i) and (ii). In a continuous process, steps (i) to (iii) may be performed consecutively or also simultaneously.

A continuous process is preferred in this invention.

In one embodiment, the additive (C) may also form a granule. This granule containing additive (C) may, preferably, be recycled into the process, e. g. together with the so-called “fines”, for example in a sieving and milling cycle.

In another ambodiment, the additive (C) may also be identical to the homo- or copolymer (B).

Furthermore, the sprinkling step (iii) may be done by spray-drying or spray-granulation, preferably spray granulation. Particularly preferred is the use of fluid bed spray granulation technology for step (iii).

In one embodiment, the process is performed in a multizone and/or multinozzle apparatus, preferably in a multizone and/or multinozzle fluid bed spray granulation apparatus.

Typical residence times are between 2 minutes and 4 hours, preferably from 30 minutes to 2 hours.

The pressure in such apparatuses is 850 mbar,abs to 1200 mbar abs, preferably normal pressure±20 mbar, for example one mbar less than normal pressure.

Bed temperatures are strongly depended from the product. Typical bed temperatures lay in a range from 40° C. to 150° C. Most times, the inlet air temperature is 20 to 150° C. higher than the bed temperature. In one embodiment, the inlet are is more than 150° C. higher than the bed temperatures.

Suitable nozzles are, for example, high-pressure rotary drum atomizers, rotary atomizers, three-fluid nozzles, single-fluid nozzles, single fluid high-pressure nozzles or two-fluid nozzles. Single-fluid nozzles and two-fluid nozzles being preferred. If a two fluid nozzle is used, than the first fluid is the aqueous slurry or aqueous solution, respectively, the second fluid is compressed gas, for example with a pressure of 1.1 to 7 bar, abs.

In one preferred embodiment of this invention, a sieving and milling step is used to adjust the particle size distribution, comprising the following steps:
(a) withdrawing powder or granules, respectively, from the spray-dryer or spray-granulator
(b) separating off fines from said powder or granules
(c) separating off oversized particles (lumps) from said powder or granules
(d) milling said lumps
(e) re-introducing said fines from step (b) and milled lumps from step (d) into the spray-dryer or spray-granulator
(f) powder or granules that have particle sizes larger than fines, but smaller than lumps are the targeted inventive granules.

A typical size for fines is (but not limited to) smaller than 0.3 mm. A typical size for oversized particles is (but not limited to) larger than 1.4 mm. The particle sizes of the fines and oversized particles are depended from the targeted product particle range.

In a preferred embodiment, the fines from step (b) and milled lumps from step (d) are introduced into zone 1.

In another embodiment, step (ii) and step (iii) are done in separate zones and/or nozzles of a multizone and/or multinozzle apparatus.

In one embodiment of the inventive process, additive (C) is added in a range of up to 30% by weight, preferably 3 to 25% by weight, relative to the sum of the contents (A), (B) and (C).

In a preferred embodiment, the at least one chelating agent (A) is selected from MGDA and its respective alkali metal salts, preferably sodium salts (e. g. trisodium salt).

In one embodiment, additive (C) may be selected from the list consisting of polymers (including biobased polymers), inorganic compounds, surfactants, silicates, preferably from the list consisting of sulfo-polymers, surfactants and inorganic compounds.

Polymer (B), and/or additive (C), may be selected from copolymers of (meth)acrylic acid and a comonomer bearing at least one sulfonic group per molecule, preferably 2-acrylamido-2-methylpropane sulfonic acid (AMPS), or polyaspartic acid.

For example, polymer (B) and/or additive (C) may be selected from bio-based and/or biodegradable polymers, for example polyaspartic acid or polyepoxysuccinic acid.

In one embodiment, polymer (B) and/or additive (C) may comprise one or more compounds selected from the group of alkoxylated polyalkylene imine or alkoxylated polyamines, which may be called “CP8” herein. “CP8” also includes the structures disclosed in WO 2021/165468, in particular in claim 1 and on pages 2 to 4 of WO 2021/165468 and the structures obtained by processes described in WO 2022/136408 and in WO 2022/136409, in particular in claim 1 and on page 3 of WO 2022/136408 and WO 2022/136409, respectively. The structures of the alkoxylated polyalkylene imine or alkoxylated polyamine may be further described by the general formula (CP8a)

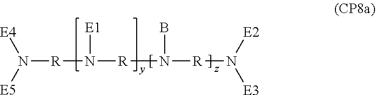

in which the variables are each defined as follows:
R represents identical or different,
   i) linear or branched C₂-C₁₂-alkylene radicals or
   ii) an etheralkyl unit of the following formula (CP8b):

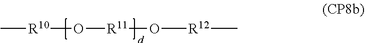

in which the variables are each defined as follows:
R¹⁰, R¹¹, R¹² represent identical or different, linear or branched C₂-C₆-alkylene radicals and
d is an integer having a value in the range of 0 to 50 or
iii) C₅-C₁₀-cycloalkylene radicals optionally substituted with at least one C₁-C₃-alkyl;
B represents a continuation of the alkoxylated polyalkylene imine by branching
y and z are each an integer having a value in the range of 0 to 150, under the proviso that both z and y are 0 in case R are C₅-C₁₀-cycloalkylene radicals optionally substituted with at least one C₁-C₃-alkyl
E1, E2, E3, E4, E5 hydrogen or represent an identical or different residue according to formula (CP8c),
   wherein the residue according to formula (CP8c) is an alkylenoxy unit defined as follows

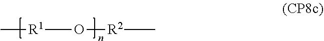

in which the variables are each defined as follows:
R¹ represents C₂-C₂₂-(1,2-alkylene) radicals;
R² represents hydrogen and/or C₁-C₂₂-alkyl and/or C₇-C₂₂-aralkyl in case z is an integer 1 within general formula (CP8b), or
   R² represents hydrogen and/or C₁-C₄-alkyl and/or C₇-C₂₂-aralkyl in case z is 0 within general formula (CP8b);
   n is an integer having a value of at least 5 to 100;
wherein 20 to 100% of the total amount of E1, E2, E3, E4 and E5 in general formula (CP8a) is a residue according to formula (CP8c).

In one embodiment, the nitrogen atoms present in CP8 are quaternized, in order to adjust the alkoxylated polyalkylene imines or the alkoxylated polyamines to the particular formulation to achieve better compatibility and/or phase stability of the formulation.

A further subject of the present invention is also a powder or granule, obtained or obtainable by the inventive process.

In a preferred embodiment of the invention, the powder or granule, obtained or obtainable by the inventive process, has a residual moisture of from 1 to 30% by weight, preferably 5 to 25% by weight.

Another subject of the present invention is the use of a powder or granule, obtained or obtainable by the inventive process, in laundry applications, dishwashing applications or industrial and institutional cleaning applications, preferably dishwashing applications, more preferably automatic dishwashing applications.

Another subject of the present invention is a cleaning agent, containing at least one powder or granule, obtained or obtainable by the inventive process, and, optionally, at least one peroxy compound, and optionally further comprising an antimicrobial agent selected from the group consisting of 2-phenoxyethanol; preferably comprising said antimicrobial agent in an amount ranging from 2 ppm to 5% by weight of the composition; more preferably comprising 0.1 to 2% of phenoxyethanol.

One further subject related to the present invention is a process for making a powder (P) or granule (G) in general, which is performed in a multizone or multinozzle drying apparatus (A) comprising 2 to n zones (Z) and/or 2 to i nozzles (N), comprising
(i) Spraying in a first zone (Z1) and/or nozzle (N1) a solution or slurry of a single compound or a mixture of compounds, and
(ii) Spraying in each of the following zones (Zn) and/or nozzles (Ni), the same or different solution or slurry of a single compound or a mixture of compounds,
wherein in at least one zone (Zx) or nozzle (Ny) the solution or slurry of a single compound or a mixture of compounds is different from the solution or slurry of a single compound or a mixture of compounds of the first zone (Z1) and/or nozzle (N1).

Preferably, said solution or slurry is aqueous.

In one embodiment, the said process is operated continuously.

In one embodiment, said process is designed to produce a powder (P) or granule (G) containing a mixture of typical ingredients of washing or cleaning formulations, wherein typical ingredients of washing or cleaning formulations may be selected from the list consisting of builders, surfactants, polymers, enzymes and inorganic compounds.

### APPLICATIONS

Inventive solid alkali metal salts (A) of an aminocarboxylate complexing agent (i. e. powders or granules), exhibit overall advantageous properties including but not limited to an excellent yellowing behavior, especially in the presence of bleaching agents. They are therefore excellently suitable for the manufacture of cleaning agents that contain at least one bleaching agent, such cleaning agent hereinafter also being referred to as bleach. In particular inventive solid compositions are suitable for the manufacture cleaning agent for fibers or hard surfaces wherein said cleaning agent contains at least one peroxy compound.

Inventive solid compositions (e. g. powders) may easily be converted into compactates and into agglomerates.

Another aspect of the present invention is therefore the use of solid alkali metal salt (A) of an aminocarboxylate complexing agent for the manufacture of a cleaning agent that contains at least one bleaching agent, and in particular for the manufacture of cleaning agent for fibers or hard surfaces, wherein said cleaning agent contains at least one peroxy compound. Another aspect of the present invention is a process for making at a cleaning agent by combining at least one inventive solid alkali metal salt (A) of an aminocarboxylate complexing agent with at least one bleaching agent, preferably at least one peroxy compound. Another aspect of the present invention is a cleaning agent, hereinafter also being referred to as inventive cleaning agent. Inventive cleaning agents contain at least one bleaching agent and at least one inventive solid alkali metal salt (A) of an aminocarboxylate complexing agent (e. g. powder). Inventive cleaning agents show a reduced tendency for yellowing and therefore have an extended shelve-life.

Examples of suitable peroxy compounds are sodium perborate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sulfonylperoxy acids and cationic peroxy acids.

In a preferred embodiment, peroxy compound is selected from inorganic percarbonates, persulfates and perborates. Examples of sodium percarbonates are 2 Na₂CO₃·3H₂O₂. Examples of sodium perborate are (Na₂[B(OH)₂(O₂)]₂), sometimes written as NaBO₂·O₂·3H₂O instead. Most preferred peroxy compound is sodium percarbonate

The term “cleaning agents” includes compositions for dishwashing, especially hand dishwash and automatic dishwashing and ware-washing, and compositions for hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, and in addition, laundry detergent compositions.

Such cleaning agents may be liquids, gels or preferably solids at ambient temperature, solids cleaning agents being preferred. They may be in the form of a powder or in the form of a unit dose, for example as a tablet or pouch.

In one embodiment of the present invention, inventive cleaning agents may contain
in the range of from 2 to 50% by weight of inventive solid alkali metal salt (A) of an aminocarboxylate complexing agent and
in the range of from 0.5 to 15% by weight of bleach.

Percentages are based on the solids content of the respective inventive cleaning agent.

Inventive solid alkali metal salts (A) of an aminocarboxylate complexing agent are excellently suited for the manufacture of laundry detergents or cleaners.

Inventive cleaning agents may contain further ingredients such as one or more surfactants that may be selected from non-ionic, zwitterionic, cationic, and anionic surfactants. Other ingredients that may be contained in inventive cleaning agents may be selected from bleach activators, bleach catalysts, corrosion inhibitors, sequestering agents other than chelating agent (A), enzymes, fragrances, dyestuffs, antifoams, and builders.

Particularly advantageous inventive cleaning agents may contain one or more complexing agents other than MGDA or GLDA. Advantageous detergent compositions for cleaners and advantageous laundry detergent compositions may contain one or more sequestrant (chelating agent) other than a mixture according to the present invention. Examples for sequestrants other than a mixture according to the present invention are IDS (iminodisuccinate), citrate, phosphonic acid derivatives, for example the disodium salt of hydroxyethane-1,1-diphosphonic acid (“HEDP”), and polymers with complexing groups like, for example, polyethyleneimine in which 20 to 90 mole-% of the N-atoms bear at least one CH₂COO⁻ group, and their respective alkali metal salts, especially their sodium salts, for example IDS-Na₄, and trisodium citrate, and phosphates such as STPP (sodium tripolyphosphate). Due to the fact that phosphates raise environmental concerns, it is preferred that advantageous inventive cleaning agents are free from phosphate. “Free from phosphate” should be understood in the context of the present invention, as meaning that the content of phosphate and polyphosphate is in sum in the range from 10 ppm to 0.2% by weight, determined by gravimetric methods and referring to the respective inventive cleaning agent.

Inventive cleaning agents may contain one or more surfactant, preferably one or more non-ionic surfactant.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (II)

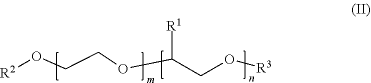

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one, preferably in the range of from 3 to 50. Preferably, m is in the range from 1 to 100 and n is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III)

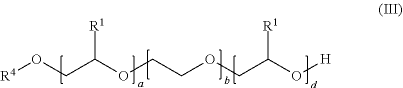

in which the variables are defined as follows:
R¹ is identical or different and selected from hydrogen and linear C₁-C₀-alkyl, preferably identical in each case and ethyl and particularly preferably hydrogen or methyl,
R⁴ is selected from C₆-C₂₀-alkyl, branched or linear, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (IV)

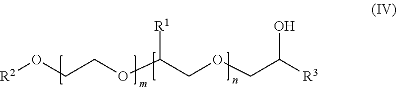

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₈-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (II) and (Ill) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (V) are likewise suitable.

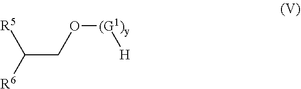

wherein the variables are defined as follows:
R⁵ is C₁-C₄-alkyl, in particular ethyl, n-propyl or isopropyl,
R⁶ is —(CH₂)₂—R⁵,
G¹ is selected from monosaccharides with 4 to 6 carbon atoms, especially from glucose and xylose,
y in the range of from 1.1 to 4, y being an average number.

Further examples of non-ionic surfactants are compounds of general formula (VII) and (VIII)

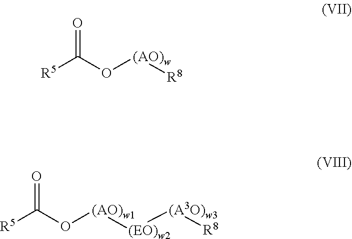

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

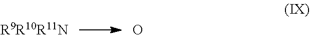

wherein R⁷, R³ and R⁹ are selected independently from each other from aliphatic, cycloaliphatic or C₂-C₄-alkylene C₁₀-C₂₀-alkylamido moieties. Preferably, R⁷ is selected from C₃-C₂₀-alkyl or C₂-C₄-alkylene C₁₀-C₂₀-alkylamido and R³ and R⁹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₃-C₁₃-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₃-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearoic acid, oleic acid, palmitic acid, ether carboxylates, and alkylether phosphates.

Preferably, laundry detergent compositions contain at least one anionic surfactant.

In one embodiment of the present invention, inventive cleaning agents that are determined to be used as laundry detergent compositions may contain 0.1 to 60% by weight of at least one surfactant, selected from anionic surfactants, amphoteric surfactants and amine oxide surfactants.

In one embodiment of the present invention, inventive cleaning agents that are determined to be used for hard surface cleaning may contain 0.1 to 60% by weight of at least one surfactant, selected from anionic surfactants, amphoteric surfactants and amine oxide surfactants.

In a preferred embodiment, inventive cleaning agents do not contain any anionic detergent.

Inventive cleaning agents may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive cleaning agents may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Inventive cleaning agents may comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, inventive cleaning agents comprise in total in the range from 0.1 to 1.5% by weight of corrosion inhibitor.

Inventive cleaning agents may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially polymers and copolymers other such as (co)polymers (B) and include polymers and copolymers than (co)polymer (B), or one additional (co)polymer (B). In one embodiment of the present invention, organic builders are selected from polycarboxylates, for example alkali metal salts of (meth)acrylic acid homopolymers or (meth)acrylic acid copolymers, partially or completely neutralized with alkali.

Suitable comonomers for (meth)acrylic acid are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M, in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of builders is carboxymethyl inulin.

Moreover, amphoteric polymers can also be used as builders.

Inventive cleaning agents may comprise, for example, in the range from in total 10 to 70% by weight, preferably from in total 10 to 50% by weight, more preferably up to 20% by weight, of builder.

In one embodiment of the present invention, inventive cleaning agents according to the invention may comprise one or more co-builders.

Inventive cleaning agents may comprise one or more antifoams, selected for example from silicone oils and paraffin oils.

In one embodiment of the present invention, inventive cleaning agents comprise in total in the range from 0.05 to 0.5% by weight of antifoam.

Inventive cleaning agents may comprise one or more enzymes. Examples of enzymes are lipases, hydrolases, amylases, proteases, cellulases, esterases, pectinases, lactases and peroxidases.

In one embodiment of the present invention, inventive cleaning agents may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive cleaning agents may comprise at least one zinc salt. Zinc salts can be selected from water-soluble and water-insoluble zinc salts. In this connection, within the context of the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO·aq, Zn(OH)₂ and ZnCO₃. Preference is given to ZnO·aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH value of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO·aq, which can be present in non-complexed or in complexed form.

Zinc salt may be present in those inventive cleaning agents that are solid at room temperature. In such inventive cleaning agents zinc salts are preferably present in the form of particles which have for example an average diameter (number-average) in the range from 10 nm to 100 μm, preferably 100 nm to 5 μm, determined for example by X-ray scattering.

Zinc salt may be present in those inventive cleaning agents that are liquid at room temperature. In such inventive cleaning agents zinc salts are preferably present in dissolved or in solid or in colloidal form.

In one embodiment of the present invention, inventive cleaning agents comprise in total in the range from 0.05 to 0.4% by weight of zinc salt, based in each case on the dry content of the cleaning agent in question.

Here, the fraction of zinc salt is given as zinc or zinc ions. From this, it is possible to calculate the counterion fraction.

In one embodiment of the present invention, inventive cleaning agents are free from heavy metals apart from zinc compounds. Within the context of the present, this may be understood as meaning that inventive cleaning agents are free from those heavy metal compounds which do not act as bleach catalysts, in particular of compounds of iron and of bismuth. Within the context of the present invention, “free from” in connection with heavy metal compounds is to be understood as meaning that the content of heavy metal compounds which do not act as bleach catalysts is in sum in the range from 0 to 100 ppm, determined by the leach method and based on the dry content. Preferably, inventive cleaning agents has, apart from zinc, a heavy metal content below 0.05 ppm, based on the dry content of the formulation in question. The fraction of zinc is thus not included.

Within the context of the present invention, “heavy metals” are deemed to be all metals with a specific density of at least 6 g/cm³ with the exception of zinc. In particular, the heavy metals are metals such as bismuth, iron, copper, lead, tin, nickel, cadmium and chromium.

Preferably, inventive cleaning agents comprise no measurable fractions of bismuth compounds, for example less than 1 ppm.

Inventive cleaning agents are excellent for cleaning hard surfaces and fibres. For example, they may be used in dishwashing applications, preferably automatic dishwashing applications.

In one embodiment of the present invention, inventive cleaning agents comprise one or more further ingredient such as fragrances, dyestuffs, organic solvents, buffers, disintegrants for tablets (“tabs”), and/or acids such as methylsulfonic acid.

From inventive solid compositions, e. g. granules or powders, examplary detergent compositions for automatic dishwashing detergents can be formulated by mixing the respective components according to the following Table F.

TABLE F
Example detergent compositions for automatic dishwashing

| All amounts in g/sample | ADW.1 | ADW.2 | ADW.3 |
|---|---|---|---|
| Inventive granule (solid | 30 | 22.5 | 15 |
| alkali metal salt) | | | |
| Protease | 2.5 | 2.5 | 2.5 |
| Amylase | 1 | 1 | 1 |
| n-C₁₈H₃₇—O(CH₂CH₂O)₉H | 5 | 5 | 5 |
| Sodium percarbonate | 10.5 | 10.5 | 10.5 |
| TAED | 4 | 4 | 4 |
| Na₂CO₃ | 19.5 | 19.5 | 19.5 |
| Sodium citrate dihydrate | 15 | 22.5 | 30 |
| HEDP | 0.5 | 0.5 | 0.5 |
| ethoxylated | optionally: | optionally: | optionally: |
| polyethylenimine, 20 EO/ | 0.1 | 0.1 | 0.1 |
| NH group, Mₙ: 30,000 g/mol | | | |

Laundry detergents according to the invention are useful for laundering any type of laundry, and any type of fibres. Fibres can be of natural or synthetic origin, or they can be mixtures of natural of natural and synthetic fibres. Examples of fibers of natural origin are cotton and wool. Examples for fibers of synthetic origin are polyurethane fibers such as Spandex® or Lycra®, polyester fibers, or polyamide fibers. Fibers may be single fibers or parts of textiles such as knitwear, wovens, or nonwovens.

Another aspect of the present invention is a process for making tablets for automatic dishwashing from an inventive solid alkali metal salt (A) of an aminocarboxylate complexing agent, e. g. a powder or granule, wherein said granule or powder is selected from inventive granules and inventive powders, respectively. Said process is hereinafter also referred to as pelletizing process according to the invention.

Inventive tablets are preferably made with the help of a machine, for example a tablet press.

The pelletizing process according to the invention can be carried out by mixing an inventive solid alkali metal salt (A) of an aminocarboxylate complexing agent, e. g. powder, with at least one non-ionic surfactant and optionally one or more further substance and then compressing the mixture to give tablets. Examples of suitable non-ionic surfactants and further substances such as builders, enzymes are listed above. Particularly preferred examples of non-ionic surfactants are hydroxy mixed ethers, for example hydroxy mixed ethers of the general formula (V).

Some aspects of the inventive process are illustrated by the following, non-limiting working examples.

### COMPARATIVE EXAMPLE 1

In a stirred vessel, a concentrated Trilon® M max (MGDA) solution at 70° C. is mixed with a Nuclesil® (silicate) 10 solution to gain a concentration of 4.5% Nuclesil®, based on the active content. Therefore, 195.937 kg of Trilon® M max liquid were heated up to 70° C. in a stirred vessel. Then, 33.515 kg of Trilon® M SG were added and solved. A clear solution was obtained. Then, 10.575 kg of Nuclesil® 10 were added to this concentrated clear solution. Immediately after the Nuclesil® 10 was added, chunks of gel where observed, that cannot be dissolved in the liquid. These chunks would block the nozzle, the experiment was stopped.

### COMPARATIVE EXAMPLE 2

In a stirred vessel, 190.427 kg of Trilon® M solution was heated to 70° C. Then, 32.573 kg of Trilon® M SG and 16.405 kg of Sokalan® CP50 (polycarboxylate, modified, sodium salt) was added. A clear solution was obtained. In a second vessel, 12.6 kg Sokalan® CP50 solution and 7.4 kg Nuclesil® 10 solution were mixed. The goal was to obtain a mixture of both liquids before the nozzle and co-granulate them. Immediately after mixing Sokalan® CP50 and Nuclesi®I 10, chunks of gel were observed, that cannot be dissolved in the liquid. As these chunks would block the nozzle, the experiment was stopped.

### EXAMPLE 1

### Preparation of the Spray Liquid SL1a and SL1b:

A concentrated Trilon® M solution was prepared by heating up 204.95 kg of Trilon® M max liquid to 70° C. and adding 35.05 kg of Trilon® M max SG. A clear solution SL1a was obtained.

Nuclesil® 10 solution was spray liquid SL1b, but was kept separately from SL1a.

In this example 1, a rectangular multi zone granulator with internal filters with 4 zones was used, commercially available as “Procell PilotSystem with GF 25 insert”. Zone 1 is at the front end of the granulator, where the milled overs are returned, zone 4 is at the back end of the granulator, were the discharge into the sieving and milling circuit is located.

In contrast to counterexample 1, the liquids in example 1 were not mixed, so SL1a and SL1b were sprayed into separate zones of a multi zone granulator. The granulator was charged with 40 kg of Trilon® M SG as initial filling. A fluidization gas of 1100-1200 Nm³/h with a temperature of 180-200° C. was introduced through the bottom plate, such that a fluidization of the Trilon® M SG granules can be observed. In zone 1 and 2, each 24.25 kg/h of SL1a were sprayed in each zone onto the fluidized granules. In zone 3, 2.24 kg/h of SL1b is sprayed onto the fluidized particles. Zone 4 was used as a cooling chamber, without feed. To keep the bed level constant, granules are continuously discharged and put onto sieves. 3 fractions were generated by this sieve: Fines with a particle size <250 μm, value fraction with particle sizes of 250-1200 μm and overs, with a particle size >1200 μm. The overs were milled down continuously and were retuned with the fines into zone 1 of the granulator. The granulation was run without interruptions.

### EXAMPLE 2

### Preparation of the Spray Liquid SL2a, SL2b and SL2c:

SL2a: 190.9 kg of Trilon® M max liquid was heated up to 70° C. Then, 32.7 kg of Trilon® max granules and 16.4 kg of Sokalan® CP50 liquid was added. A clear solution was obtained.
SL2b: Sokalan® CP50 solution, heated up to 50° C.
SL2c: Nuclesil® 10 solution

The spray liquids were kept separately.

The granulation of example 2 took place the same way as described in example 1. This time, 24.2 kg/h of SL2a were sprayed each into zone 1 and zone 2. In zone 3, 10.4 kg/h of SL2b was sprayed. In zone 4, 2.6 kg/h of SL2c was sprayed. The granulation was run for 2 h continuously.

The examples show that by using the inventive process, the process runs smoothly as desired, even if several compounds which may be incompatible with each other are used. On the other hand, the comparative examples—where the inventive process was not utilized—led to severe problems in the process, thus had to be discontinued.

1. A process for making a powder (P) or granule (G) comprising
(a) at least one chelating agent (A) selected from methyl glycine diacetic acid (MGDA), glutamic acid diacetate (GLDA), iminodisuccinic acid (IDS), citric acid and Ethylediamine disuccinic acid (EDDS), their respective alkali metal salts and their mixtures, and (b) optionally, at least one homo- or copolymer (B) of (meth)acrylic acid, partially or fully neutralized with alkali,
said process comprising the steps of
(i) mixing the at least one chelating agent (A) and, optionally, the at least one homo- or copolymer (B) in the presence of water,
(ii) removing most of said water by spray-drying or spray granulation to obtain intermediate powder (IP) or granule (IG), and
(iii) sprinkling at least one additive (C) in an amount of up to 50% by weight, relative to the complete weight of the resulting powder (P) or granule (G), on the surface of intermediate powder or granule (I), to obtain final powder (P) or granule (G),
wherein the process is performed in a multizone and/or multinozzle apparatus, wherein step (ii) and sprinkling step (iii) are done in separate zones and/or nozzles of the multizone and/or multinozzle apparatus.

2. The process according to claim 1, wherein the process is continuous.

3. The process according to claim 1, wherein the process is a batch process.

4. The process according to claim 1, wherein the sprinkling step (iii) is done by spray-drying or spray granulation.

5. (canceled)

6. The process according to claim 1, wherein additive (C) is added in a range of up to 30% by weight, relative to the sum of the contents of (A), (B) and (C).

7. The process according to claim 1, wherein the at least one chelating agent is methyl glycine diacetic acid (MGDA) and/or its respective alkali metal salts, optionally sodium salts.

8. The process according to claim 1, wherein the additive (C) is selected from the group consisting of polymers, inorganic compounds, surfactants, silicates, and sulfo-polymers.

9. The process according to claim 1, wherein said polymer (B) and/or additive (C) is selected from copolymers of (meth)acrylic acid and a comonomer bearing at least one sulfonic group per molecule, optionally 2-acrylamido-2-methylpropane sulfonic acid (AMPS), or polyaspartic acid or polyepoxysuccinic acid.

10. A powder or granule, obtained or obtainable according to the process of claim 1.

11. The powder or granule according to claim 10, having a residual moisture content in the range of from 1 to 30% by weight.

12. (canceled)

13. A cleaning agent comprising at least one powder or granule according to claim 10, and, optionally, at least one peroxy compound, and optionally further comprising an antimicrobial agent selected from 2-phenoxyethanol.

14. The process according to claim 1, wherein step (ii) is performed using a gas with an inlet temperature of at least 125° C.

15. The process according to claim 1, wherein, in step (iii), the at least one additive (C) is contained in a solution or slurry.

16. The process according to claim 1, wherein the multizone and/or multinozzle apparatus is a multizone and/or multinozzle fluidized bed spray granulation apparatus.

17. The process according to claim 1, wherein the sprinkling step (iii) is done by fluid bed spray granulation.

18. The process according to claim 1, wherein additive (C) is added in a range of 3 to 25% by weight.

19. The powder or granule according to claim 10, having a residual moisture content in the range of 5 to 25% by weight.

20. A process for cleaning comprising applying the powder or granule from claim 1 to a hard surface or fiber.
